(19) United States
(12) Patent Application Publication
(10) Pub. No.: US 2002/0066801 A1
(43) Pub. Date: Jun. 6, 2002

(54) Fluid atomising device

(76) Inventors: Edward Hugh Owens, West Linton (GB); George Henry Smith, Edinburgh (GB); Mark Thomas Leonard, Edinburgh (GB)

Correspondence Address: VENABLE, BAETJER, HOWARD AND CIVILETTI, LLP, P.O. BOX 34385, WASHINGTON, DC, 20043-9998, US

(21) Appl. No.: 10/025,931

(22) Filed: Dec. 26, 2001

(30) Foreign Application Priority Data
Dec. 23, 2000 (GB) 0031673.7
May 23, 2000 (GB) 0012518.7

(51) Int. Cl. B05B 3/04

(52) U.S. Cl. 239/222.19; 239/382

(57) ABSTRACT

The present invention provides a fluid atomizing device 1 suitable for use in a fluid dispersing system. The atomizing device 1 comprises a turbine rotor 6 having a plurality of blade portions 22, and at least two nozzles for directing a fluid supplied to the nozzles, onto the turbine rotor in at least two fluid jets 24. The nozzles 14 are formed and arranged so that each fluid jet 24 impinges substantially fully upon one or more of the blade portions 22 of the rotor 6 so that the rotor is rotated under the force of the impinging water, thereby causing the blade portions 22 of the rotor 6 to intercept the fluid jets 24.

The present invention relates to sprinkler devices suitable for dispersing fluid into a more or less mist-like form.

Water dispersing systems incorporating sprinkler devices are well-known and are used in a variety of forms (static, rotary, oscillating etc.) in a wide range of applications such as in fire suppression systems, in agricultural/horticultural systems and in commercial automated vehicle wash systems. Where a water dispersing system is used for example, to water plants, care must be taken not to damage seedlings and/or delicate plants. Additionally, it is highly desirable to provide an even distribution of water over a particular area of choice to be watered. Damage to seedlings and/or delicate plants can occur where the water droplet size is too large, and may also occur where water strikes the seedling plants with too much force.

It is known to provide a sprinkler device having a rotor means which is rotated by for example a motor so to enable the rotor to disperse a water jet impinging upon the powered rotor. Such devices can be expensive to run since they require power to rotate the rotor.

WO 96/01153 and GB 2 330 783A describe sprinkler devices in which a rotor is rotated in turbine fashion, under the action of laminar flow jets of water. Some or all of the jets of water are arranged to make partial or “skliffing” contact with the edges of turbine blades of the rotor so as to produce a mist of water droplets. One problem encountered in practice with this design is that the spray or mist generated by the device tends to be inhomogeneous, the respective plumes of spray from the various jets being clearly discernible in the overall spray pattern.

It is an object of the present invention to avoid or minimise one or more of the foregoing disadvantages.

The present invention provides a fluid atomising device suitable for use in a fluid dispersing system wherein the atomising device comprises a turbine rotor having a plurality of blade portions, and at least two nozzles for directing a fluid, supplied to the nozzles in use of the device, onto the turbine rotor in at least two fluid jets, and wherein the nozzles are formed and arranged so that, in use, each said fluid jet impinges substantially fully upon one or more of the blade portions of the rotor, so that the rotor is rotated under the force of the impinging water, thereby causing the blade portions of the rotor to intercept said fluid jets.

The atomizing device of the present invention provides a fine and substantially homogeneous mist which is particularly useful in a number of different applications—without the need for any separate power source for rotating the rotor thereof. Suitable applications which may be mentioned include fire suppression systems; various agricultural/horticultural systems for watering, humidifying, delivering nutrient and/or treatment fluids; commercial automated washing systems, for example for washing vehicles; scrubbing systems for removing particulates and/or soluble components from flue gases and the like; aerating systems such as for example those used in waste water treatment installations in order to oxygenate the water in order to promote microbial digestion of waste materials present therein, etc. Thus in yet another aspect the present invention provides such a system characterized by the use of an atomizing device of the present invention.

When fluid, preferably water, is supplied to the nozzles at a sufficiently high pressure, the atomising device produces a plume of fine droplets of fluid due to the action of the turbine blade portions upon the high velocity fluid jets. The rotor is driven by the force of the fluid jets striking the blade portions, without the need for the rotor to be powered by a secondary drive means.

For the avoidance of doubt, each fluid jet impinges substantially fully upon one or more said blade portions in the sense that said blade portion(s) upon which the jet impinges, intersect the jet across substantially the full diameter of the jet.

It will be appreciated that the blade portions can take a variety of forms including, but not limited to: conventional turbine blades where the blade portions are typically relatively thin members projecting from a rotor body, or parts of channels or passages formed in or through a rotor body.

The turbine rotor blade portions are preferably formed and arranged so as to substantially continuously intercept each said fluid jet from the nozzles, in use of the atomising device. Preferably there are a multiplicity of said blade portions which are arranged circumferentially about the rotor, advantageously from 10 to 25, preferably from 12 to 18. Each blade portion preferably comprises a plurality of angled surfaces provided on the rotor. Desirably the blade portions may each have a profile which varies either substantially continuously or disingenuously. The incidence angle at which each fluid jet impinges upon the blade portions may therefore vary substantially continuously or disingenuously concomitant with the profile of the blade portion towards which said fluid jet is directed by the nozzles, in use.

The nozzles are preferably mounted in a stator body about which the rotor rotates. Bearing means is preferably provided between the stator and rotor, providing at least one bearing surface, therebetween. Desirably, the bearing means comprises stable low friction material such as, for example, Torlon or Vesconite (both Trade Marks). This ensures steady rotation of the rotor relative to the stator. Alternatively, either the rotor and/or stator could be made from such a material, so as to minimise friction therebetween, although this is generally less preferred since a rotor made of low friction material may exhibit erosion problems due to the action of the impinging jets and/or a stator made of low friction material could limit the maximum pressure of fluid which can be supplied to the nozzles. In yet another alternative there may be used an annular bearing mechanism, conveniently a ball or roller bearing device, which advantageously is provided with suitable protection, for example labyrinth seals either side thereof, so as to make it substantially resistant to water ingress and damage.

Preferably, the stator is provided with an inner hollow core portion which is in fluid communication with said nozzles. This core portion is preferably generally cylindrical and substantially aligned with a longitudinal axis of the atomising device about which axis the rotor rotates. In use of the atomiser device, water is supplied, preferably by a pump device, to said inner core portion, which water then exits the nozzles as fluid jets which impinge substantially fully and, preferably, continuously upon the rotor blade portions, as above described.

The nozzles may be formed integrally in the stator or, preferably, are removable nozzles seated in the stator body so as to direct the fluid jets at said rotor blade portions as described herein above. Each nozzle preferably comprises an orifice in the form of a generally cylindrical bore in a nozzle body which is detachably mounted in a stator body so as to be removable from the stator, this cylindrical bore being in fluid communication with said central core portion of the device. The diameter of the orifices may vary axially therealong, for example the orifice may widen towards its outward (outlet) end. Preferably, the chosen diameter of the orifices is sufficiently small, and the water is pumped to the device, in use, under sufficiently high pressure, that the water flow in the water jets issuing from the orifices is substantially turbulent. Preferably the diameter of each orifice is in the range of 0.5 mm to 1.5 mm. With such orifice diameters, a desired average water flow-rate is from 1 liter/minute to 2.6 liters/minute approximately, through each orifice. Nevertheless significantly larger diameters may be appropriate for at least some applications and/or with larger sizes of atomizing device.

When the turbulent fluid jets from the nozzles impact fully on the rapidly rotating turbine blades, in use of the device, the cohesive forces of the water jets are destroyed, thereby producing a plume of fine water droplets having a mean diameter of preferably less than 100 μm.

In one convenient form of the invention, the rotor is formed and arranged such that the blade portions are constituted by parts of the walls of passages which extend radially outwardly of the rotor, wherein the passages each have a fluid inlet to receive a said fluid jet and a fluid outlet, the inlet being located radially inwardly of the outlet. It will of course be appreciated that in order for the fluid jet to impinge substantially continuously on one or more blade portions, each located within or forming part of the inner surface forming the passages, then the fluid jet should have substantially continuous access to said one or more blade portions. Where the passages are not substantially wholly adjacent to one another, then, for the fluid jet to have substantially continuous access to the blade portions, at least the fluid inlet of each passage should have a relatively large diameter and/or be shaped such that the edges of successive inlets are substantially adjacent, thereby allowing a fluid jet substantially continuous access to said one or more blade portions.

Preferably, the blade portions form at least part of an inner surface forming the passages.

Alternatively, the blade portions may be constituted by blades located within and extending across at least part of the inner diameter of said passages so that a fluid jet impinges thereon in use of the device of the present invention.

The passages may be of any shape of cross-section, for example circular, elliptical, square, triangular or polygonal. Moreover, the shape and size of the cross-section of the passages may vary along the longitudinal extent thereof from the inlet to the outlet.

The nozzles are preferably arranged to direct a fluid jet into the passages through said inlets so that, in use, the fluid jet strikes said blade portions of the passages and exits through the outlets thereof.

Where the blade portion forms at least part of the inner surface of the passage, the longitudinal axis of the passage is preferably arranged to extend at an angle which is offset from the longitudinal axis of the fluid jet within a plane which includes the longitudinal axis of the fluid jet and the rotational axis of the rotor. That is the fluid jet strikes the blade portion at an incidence angle within the horizontal plane formed between the longitudinal axis of the fluid jet and at least part of a said blade portion. The passages are preferably angled relative to the longitudinal axis of the device so as to lie in a conical surface plane. The cone angle (θ) may be in the range of from 20° to 160°, preferably from 50° to 120°, and most preferably about 90°. In general the blade portions extend in a direction which is offset from a radial direction in order to provide rotation of the rotor when the fluid jet impacts the blade portions. Preferably the offset is by an angle of from 15 to 40°, advantageously from 20 to 35°.

The nozzles may take the form of a set of screw-in implants or other removable forms which may be fitted into a corresponding set of openings provided in the stator body. Desirably, a plurality of sets of nozzles may be provided so that there are more nozzles than there are openings provided therefore in the stator, and at least some of the nozzles may have different size orifice diameters whereby one said nozzle of one diameter may be exchanged for another said nozzle having a different diameter. The feature of providing exchangeable nozzles of different diameters is significantly advantageous in that different diameter fluid jets can be produced by the device by changing nozzles. Additionally, should a nozzle become blocked or damaged, then it may be easily replaced by another such nozzle, thereby allowing more or less continuous operation of the atomiser device while the blocked/damaged nozzle is unblocked or repaired.

The nozzles are preferably spaced circumferentially about the longitudinal axis of the device and are angled thereto so as to lie in a conical plane. The cone angle (θ) may be in the range of 20° to 160°, preferably substantially 90°. The water jet from each nozzle, upon impacting with the turbine blades, forms a plume or spray of water which expands radially outwardly from the rotor to produce an expanding arc of water droplets. Each such plume produced by a nozzle of the atomiser device preferably has an angle of spread which is in the range of from 30 degrees to 45 degrees to the axis of the nozzle. The individual plumes produced from the nozzles merge together and disperse from the device as a single “grand” plume.

At least some of the nozzles may also be configured so that the cylindrical bores thereof are angled at different angles to the longitudinal axis of the device when they are located in the openings provided to receive them in the stator. In this manner the angle of the fluid jets relative to the rotor blade portions can be varied by interchanging nozzles.

Without being bound by theory it is believed that when the fluid jet strikes the blade portion the impact of the body of water in the fluid jet on the blade portion, at least partially, destroys the cohesive forces binding the body of water in the fluid jet together. At least a portion of the momentum of the fluid jet is transferred to the rotor from the fluid jet striking the blade portion, which thereby causes the rotor to rotate. The radial and circumferential acceleration of the fluid as it passes over the surface of the blade portion produces a further atomising effect. The spreading of the water in the fluid jet into a thin layer or sheet as it accelerates over the blade portion and the subsequent instability of the sheet of water as it is thrown radially outwards from the blade portion produces a finely atomised plume of droplets of water as the rotor rotates.

Further preferred features and advantages of the present invention will appear from the following detailed description given, by way of example only, of a preferred embodiment of the invention which is now described with reference to the accompanying drawings in which:—

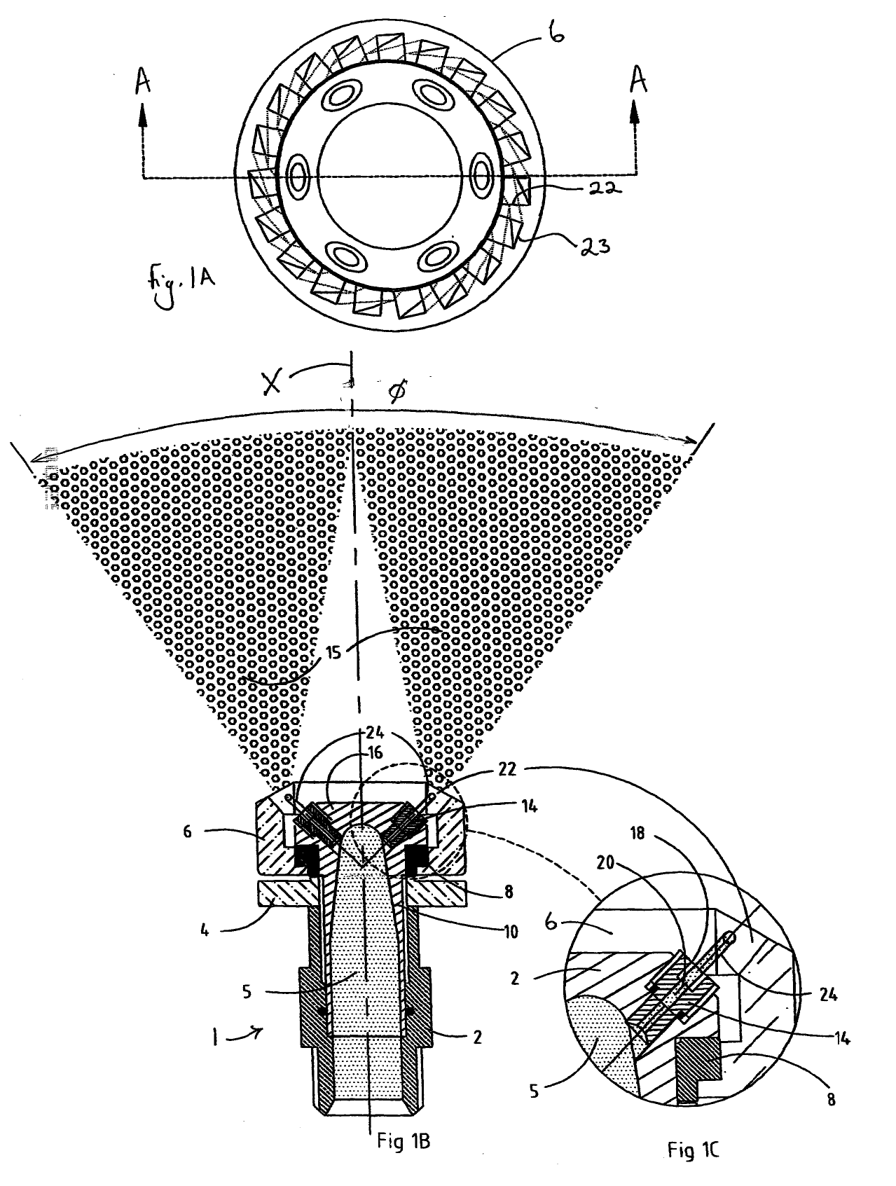

FIG. 1A is a plan view of an atomising device according to a first embodiment of the invention;

FIG. 1B is a cross-sectional view of the atomising device of FIG. 1A, taken along the line A-A in FIG. 1A;

FIG. 1C is a magnified view of a portion of FIG. 1B, showing in detail a nozzle of the device;

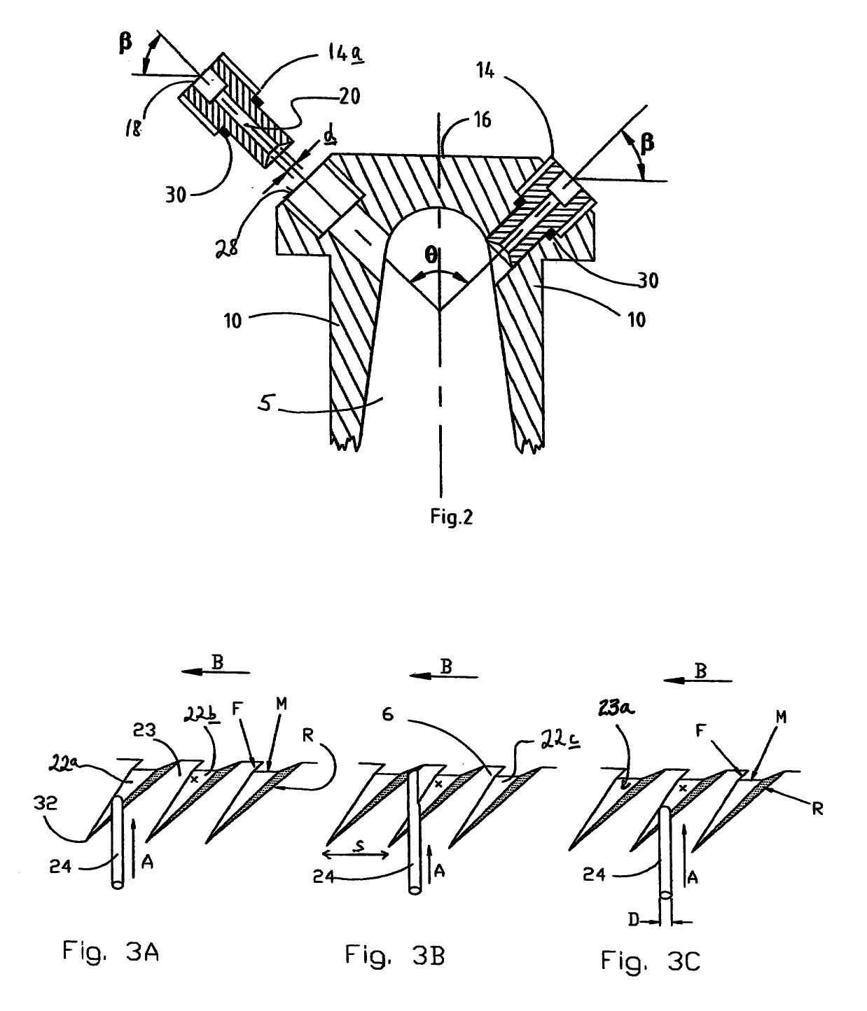

FIG. 2 is a cross-sectional view, taken along the line A-A in FIG. 1A, of part of a stator of the atomising device, showing two replaceable nozzles;

FIGS. 3A-C are drawings illustrating a water jet continuously impacting on a moving rotor of the device of FIGS. 1 and 2;

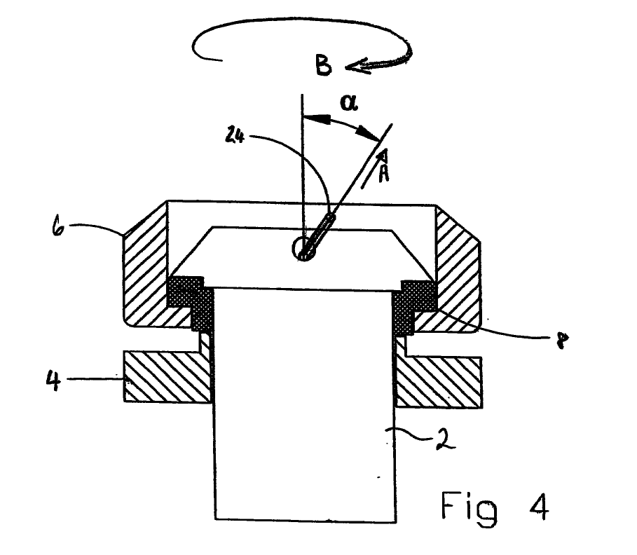

FIG. 4 is a part cross-sectional view of a portion of the device of FIG. 1B;

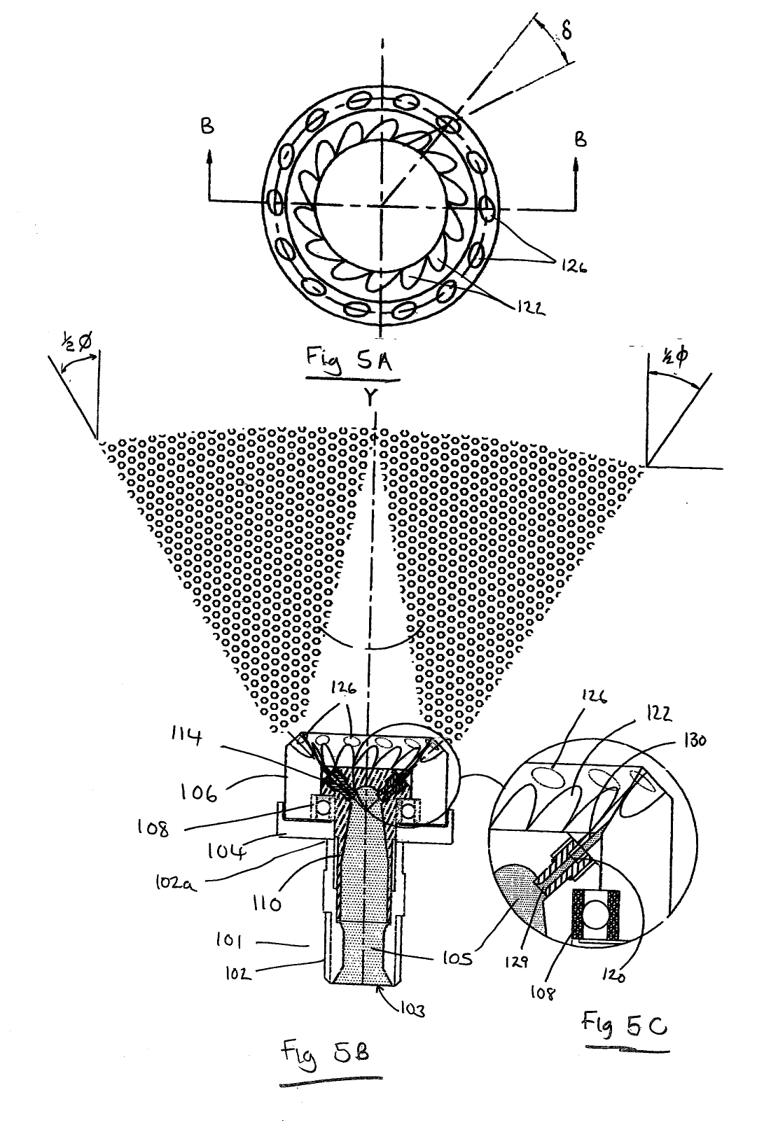

FIG. 5 is a plan view of a rotor according to a second embodiment of the present invention;

FIG. 5B is a cross-sectional view of an atomising device according to a second embodiment of the present invention featuring the rotor of FIG. 5A taken through B-B;

FIG. 5C is a magnified view of a portion of FIG. 5B, showing in detail another nozzle of the device;

FIG. 6 is a schematic exploded cross-sectional view of the device of FIGS. 5B-5C;

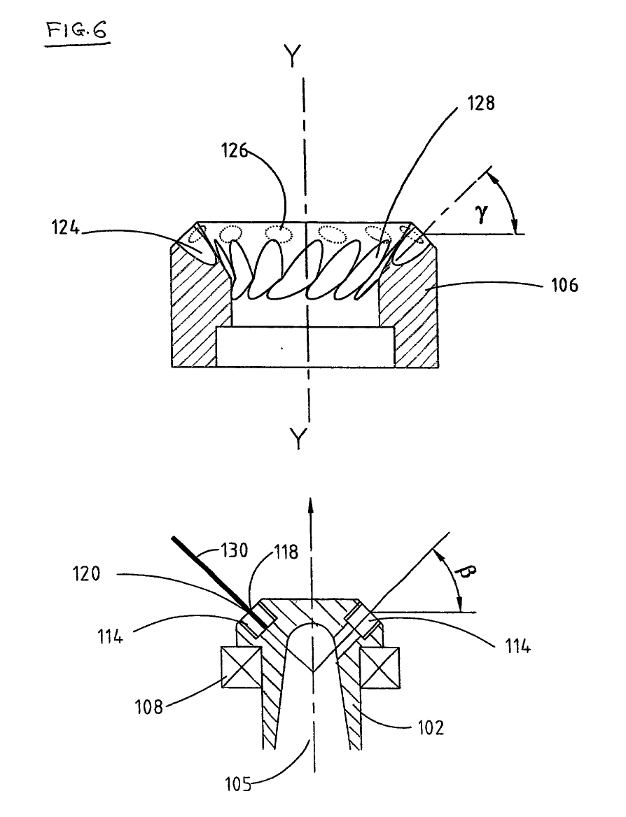

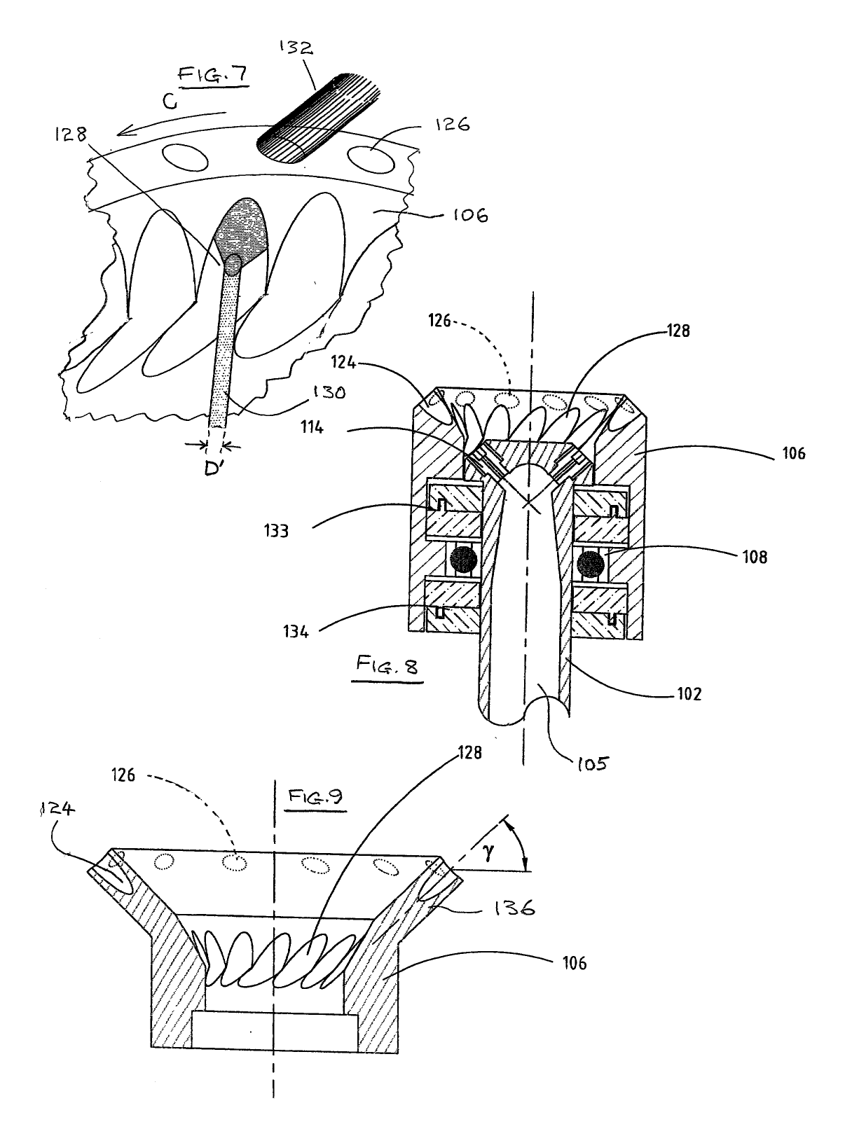

FIG. 7 is a schematic part cross-sectional view of a portion of the rotor of FIGS. 5B-5C;

FIG. 8 is a sectional view corresponding generally to FIG. 1B of a further embodiment with a highly water resistant bearing arrangement; and

FIG. 9 is a sectional view of a modified rotor for use in an atomising device of the invention.

An atomising device 1 (hereinafter referred to as the “atomiser” 1) according to a first embodiment of the present invention is shown in FIGS. 1A, 1B and 1C. The atomiser 1 has an upright generally cylindrical hollow bodied stator 2 which incorporates a disc-like collar portion 4 located towards an upper end 2a thereof. The stator 2 comprises an axial inner core or passageway 5 in fluid communication with a water inlet 3, for connection to a pumped water supply (now shown) in use of the device. A generally cap-shaped rotor 6 is rotatably mounted about the stator 2, just above the collar portion 4 of the stator 2. A bearing 8 is located between the rotor and an inner sleeve portion 10 of the stator 2 which protrudes above the collar portion 4. The bearing 8 is made of Torlon to provide substantially free rotation of the rotor in use of the device 1, so that a steady rotational velocity of the rotor 6 can be maintained. The bearing 8 is configured so that the rotor 6 does not have any surfaces which bear directly on the stator (i.e. all bearing surfaces are on the bearing 8).

Six removable fluid jet nozzles 14 are circumferentially arranged in the protruding end 16 of the inner sleeve portion 10 of the stator. Each fluid jet nozzle 14 has an outlet orifice 18 of diameter 2 mm at the end of a cylindrical fluid conduit 20 of inner diameter d which is in the range of from 0.6 to 1.5 mm and which is in fluid communication with the axial inner passageway 5 of the stator 2 (see FIG. 1B). The nozzles 14 are seated in the stator so that the fluid conduit 20 of each nozzle is angled to the longitudinal axis X of the device 1 at approximately 45°, the nozzles thereby lying in a conical plane of cone angle 90°. The nozzles 14 are directed towards turbine blade portions 22 on the rotor 6. The blade portions 22 are integrally formed in the rotor and are circumferentially spaced about the axis of the rotor, as seen most clearly from FIG. 1A. As seen in FIGS. 1A and 1B, the blades are located at the outer (i.e. upper in FIG. 1A) end 6a of the cap-shaped rotor 6. As best seen from FIG. 1, each blade portion 22 consists of three angled surfaces, these being a forward F, middle M, and rear R surface, which converge generally downwardly towards an apex 32. The blade portions can thus be viewed as defining a series of generally pyramid-shaped projections in the rotor 6. The structure of the blade portions is described in further detail later.

In use of the atomiser 1 water (indicated by dotted shading) is pumped (using a pump—not shown) through the inner passageway 5 of the stator, from where it is forced out the outlets 18 of the nozzles 14. The water exits each nozzle outlet 18 in the form of a jet 24 which is directed towards, and impacts fully upon the blade portions 22 of the rotor 6, (i.e. the full diameter D of each jet strikes the rotor). The force of the water jets 24 striking the blade portions 22 (and thus the momentum impacted to the rotor thereby) causes the rotor 6 to rotate about the stator 2 at high speed. The water is pumped to the stator at a sufficiently high pressure (for the given number and diameter of the nozzle outlets 18) to cause turbulent flow in the jets 24. In a typical example, we use a 30 bar water pressure (supplied to the stator) for an atomiser 1 having six nozzle outlets of 0.8 mm orifice, and water will issue from the atomiser at a rate of 10.2 liters/minute and the rotor 6 will rotate at a typical speed of 13,200 rpm. The blade portions of the rapidly rotating rotor 6 continually intercept the turbulent water jets 24, breaking the structure of the jets apart, forming a high density of water droplets with an average droplet size of <100 μm. The rotation of the turbine tends to throw the droplets created from each colliding jet tangentially away from the rotor, thus producing a plume 15 of droplets. Each individual nozzle produces such a plume of droplets and these plumes merge together and disperse away from the atomising device as a single “grand” plume having an overall angle of spread φ, as illustrated in FIG. 1.

FIG. 2 shows in detail the upper end 16 part of an inner sleeve portion 10 of the stator 2, illustrating the removable nature of a nozzle 14a. A socket 28 in the stator 2 is formed and arranged to receive the nozzle 14a which is screwed (threads not shown) into the socket 28. A watertight seal between the nozzle 14a and the socket 28 is achieved by use of an o-ring/washer 30 placed therebetween. The cone angle (β) between nozzles 14 and 14a is 90°, such that each nozzle 14 points upwardly at an angle (β) of 45° to the horizontal.

The three angled surfaces F, M, R of each blade portion 22 are configured in the rotor so that each water jet 24 is continuously intercepted by the blade portions 22 of the rotor 6, as described above. This is illustrated in FIGS. 3A to 3C. These show a water jet 24 (from one of the jet nozzles 14) travelling, in the direction indicated by arrow A, towards blade portions 22 of the rotor. The blade portions of the rotor are in practice formed by cutting away portions of the rotor component at manufacture so as to define the blade surfaces F, M, R of each blade portion 22 in the rotor 6. As will be appreciated from FIG. 1A and FIGS. 3A-C, and as afore-described, each blade portion 22 of the rotor comprises a generally pyramid-shaped projection 23 defined by three adjacent, elongate, and generally V-shaped surfaces F, M, R on the rotor which surfaces F, M, R form a channel 23a (FIG. 3C) therebetween. These V-shaped surfaces point generally downwardly from the upper end 16 of the rotor, and generally forwardly with respect to the direction of rotation B. Two of these three V-shaped surfaces, namely the middle M and rear R of the three, act as the turbine blade surfaces upon which the jets 24 impinge. The force of the jets 24 striking these blade surfaces M, R causes the rotor 6 to rotate in the direction indicated by arrow B in FIGS. 3A-C. In each of FIGS. 3A-C three adjacent blade portions 22a, b, c are shown as they would rotate past the jet 24 in the direction of rotation B. FIGS. 3A-C illustrate three sequential positions of the blade portions during rotation of the rotor in direction B, as illustrated clearly by the middle surface M of the second blade portion 22b, marked with an X, which can be seen to be moving towards the jet 24. The turbine blade portions are projecting out of the plane of the paper in FIGS. 3A-C. The jet 24 originates from in front of the plane of the paper and is directed in an upward direction in towards the plane of the paper. FIG. 3A shows the jet 24 hitting the first blade portion 22a in the sequence, on the middle blade surface F. FIG. 3B shows the jet 24 hitting both the rear blade surface R of the first blade portion 22a and the middle blade surface M of the second blade portion 22b. It can be seen that before the jet 24 stops hitting the rear blade surface R of the first blade portion 22a and can escape between the first and second blade portions (through the indented channel 23 defined therebetween) the middle blade M of the second blade portion interrupts the jet to prevent this happening. FIG. 3C shows the jet 24 fully hitting the middle blade surface F of the second blade portion 22b.

The relative angles of the two blade surfaces M, R of each blade portion, and the size S of the circumferential spacing of adjacent blade portions, are all chosen so that there is an overlap of the trailing blade surface R of one blade portion 22a and the middle blade surface M of the adjacent blade portion 22b, in the direction A of the jet 24, as described above with reference to FIG. 3B. This means that the jet 24 is continuously intercepted by at least one, sometimes two, of the blade surfaces as the rotor rotates. Moreover, the shape and surface area of each of the blade surfaces M, F is chosen so that the whole cross-section of the jet 24 impinges upon one or more blade portions 22 of the rotor at any time. As seen from FIGS. 3A-C, at any one time the whole diameter of the jet 24 may be intercepted by only one blade surface (as in FIGS. 3A and B), or by a plurality of blade surfaces (as in FIG. 3C).

It will be appreciated that various modifications and variations to the above-described embodiment is possible without departing from the scope of the invention. For example, other types of bearing material than Torlon could be used, for example Vesconite is another suitably low friction material.

Additionally, more than one set of nozzles 14 may be provided for the atomiser 1. For example, a spare set 6 of nozzles having different orifice diameter to the first set 6 of nozzles may be provided, so that by interchanging the nozzles different diameter water jets can be produced. If desired, the spare nozzles may also be configured so that the fluid bores thereof are at a different angle to the longitudinal axis X of the device, as compared to the fluid bores of the first set of nozzles, when seated in the stator. In this manner, the angle at which the water jets strike the blade surfaces of the rotor can be varied.

An atomising device 101 (hereinafter referred to as the “atomiser” 101) according to a second embodiment of the present invention is shown in FIGS. 5A, 5B and 5C. The atomiser 101 has an upright generally cylindrical hollow bodied stator 102 which incorporates a disc-like collar portion 104 located towards an upper end 102a thereof. The stator 102 comprises an axial inner core or passageway 105 in fluid communication with a water inlet 103, for connection to a pumped water supply (not shown) in use of the device 101. A generally cap-shaped rotor 106 is rotatably mounted about the stator 102, just above the collar portion 104 of the stator 102. A bearing 108 is located between the rotor 106 and an inner sleeve portion 110 of the stator 102 which protrudes above the collar portion 104. The bearing 108 is made of Torlon to provide substantially free rotation of the rotor 106 in use of the device 101, so that a steady rotational velocity of the rotor 106 can be maintained. The bearing 108 is configured so that the rotor 106 does not have any surfaces which bear directly on the stator 102 (i.e. all bearing surfaces are on the bearing 108).

Six (two shown) removable fluid jet nozzles 114 are circumferentially arranged in the protruding end 116 of the inner sleeve portion 110 of the stator. Each fluid jet nozzle 114 has an outlet orifice 118 of diameter 2 mm at the end of a cylindrical fluid conduit 120 of inner diameter d (see FIG. 2) which is in the range of from 0.6 to 1.5 mm and which is in fluid communication with the axial inner passageway 105 of the stator 102 (see FIG. 5B). The nozzles 114 are seated in the stator 102 so that the fluid conduit 120 of each nozzle is angled to the longitudinal axis Y of the device 101 at approximately 45°, the nozzles 14 thereby lying in a conical plane of cone angle 90°. The nozzles 114 are directed towards an inlet 122 of a circular section fluid channel 124 which extends vertically at an angle (γ) of 45° from the horizontal. The channel 124 exists at a fluid outlet 126 located on the outer circumference of the rotor 102. The inner surface of the channel 124 forms a blade portion 128 (FIG. 6). The blade portions 128 which are integrally formed in the fluid channel 124 which are circumferentially spaced about the rotational axis of the rotor 102, as seen most clearly from FIG. 5A.

In use of the atomiser 101, water 129 (FIG. 7, indicated by dotted shading) is pumped (using a pump—not shown) through the inner passageway 105 of the stator, from where it is forced out the outlets 118 of the nozzles 114. The water exits each nozzle outlet 118 in the form of a jet 130 which is directed towards, and impacts fully upon the blade portions 128 of the rotor 106, (i.e. the full diameter D′ of each jet strikes the rotor 106). The force of the water jets 130 striking the blade portions 128 within the channel 124 (and thus the momentum impacted to the rotor 106 thereby) causes the rotor 106 to rotate (as indicated by arrow C) about the stator 102 at high speed. The water 129 is pumped to the stator 102 at a sufficiently high pressure (for the given number and diameter of the nozzle outlets 118) to cause turbulent flow in the jets 130. In a typical example, we use a 30 bar water pressure (supplied to the stator) for an atomiser 1 having six nozzle outlets of 0.8 mm orifice, and water will issue from the atomiser at a rate of 10.2 liters/minute and the rotor 6 will rotate at a typical speed in the range from 10,000 to 15,000 rpm. The blade portions 128 of the rapidly rotating rotor 106 continually intercept the turbulent water jets 130, breaking the structure of the jets apart, forming a high density of water droplets with an average droplet size of <100 μm. The rotation of the turbine tends to throw the droplets created from each colliding jet tangentially away from the rotor, thus producing a plume 132 of droplets. Each individual nozzle produces such a plume of droplets and these plumes merge together and disperse away from the atomising device as a single “grand” plume having an overall angle of spread φ, as illustrated in FIG. 1. The fluid channels 124 extend at around 45° (γ) relative to the horizontal, and are off set from the radius within the horizontal plane by an angle (δ) of 25° (see FIG. 5A). The offset angle (δ) ensures that the blade portions 128 allow the transfer of at least a portion of the momentum from the water jet 130 to the rotor 106 which is thereby rotated. As the rotor 106 rotates in the direction of arrow C the water jet 130 substantially continuous impinges upon one or more blade portions 128 of adjacent passages 124.

In FIG. 8 like parts corresponding to those of the earlier described embodiments. In this case the ball race bearing 108 is substantially projected against ingress of water, by means of labyrinth seals 133, 134 above and below it.

FIG. 9 shows a modified rotor 106 provided with a belled out distal end portion 136 extending upwardly and outwardly in the frusto-conical plane of the fluid channels 124 so that the fluid channels 124 have an increased length and the fluid outlets 126 thereof are disposed at an increased diameter. This results in an increased tangential speed of the release point of the fluid for a given rotational speed of the rotor which will tend to provide a smaller droplet size.

What is claimed is:

1. A fluid atomising device suitable for use in a fluid dispersing system wherein the atomising device comprises a turbine rotor having a plurality of angularly distributed blade portions, and at least two nozzles for directing a fluid, supplied to the nozzles in use of the device, onto the turbine rotor in at least two fluid jets, and wherein the nozzles are formed and arranged so that, in use, each said fluid jet impinges substantially fully upon one or more of the blade portions of the rotor, so that the rotor is rotated under the force of the impinging water, thereby causing the blade portions of the rotor to intercept said fluid jets.

2. A device according to claim 1 wherein said blade portions are substantially constituted by thin blade members projecting from a rotor body.

3. A device according to claim 1 wherein said blade portions are substantially constituted by walls of channels formed in a rotor body.

4. A fluid atomising device suitable for use in a fluid dispersing system wherein the atomising device comprises a turbine rotor comprising a rotor body with a plurality of angularly distributed blade portions substantially constituted by walls of passages formed in said rotor body, and at least two nozzles for directing a fluid, supplied to the nozzles in use of the device, onto the turbine rotor in at least two fluid jets, and wherein the nozzles are formed and arranged so that, in use, each said fluid jet impinges substantially fully upon one or more of the blade portions of the rotor, so that the rotor is rotated under the force of the impinging water, thereby causing the blade portions of the rotor to intercept said fluid jets.

5. A device according to claim 4 wherein the blade portions are formed and arranged so as to provide a substantially continuous interception of the fluid jets in use of the device.

6. A device according to claim 4 wherein each blade portion has a plurality of differently angled surfaces.

7. A device according to claim 6 wherein said differently angled surfaces constitute a surface with a continuously varying angle.

8. A device according to claim 7 wherein said surface is defined by a passage having a circular cross-section.

9. A device according to claim 8 wherein at least an upstream end portion of said passage is convergent in a radially outward direction.

10. A device according to claim 4 wherein the passages are angled relative to the longitudinal axis of the device so as to lie in a conical surface plane having an included cone angle (θ) in the range of from 20° to 160°.

11. A device according to claim 10 wherein said cone angle is from 50° to 120°.

12. A device according to claim 4 wherein the blade portions extend in a direction which is offset from a radial direction by an angle of from 15 to 40°.

13. A device according to claim 12 wherein the blade portions extend in a direction which is offset from a radial direction by an angle of from 20 to 35°.

14. A device according to claim 4 wherein said nozzles are detachably mounted in a body portion of said stator.

15. A device according to claim 4 wherein are provided from 2 to 8 nozzles.

16. A device according to claim 4 wherein the nozzles are angled relative to the longitudinal axis of the device so as to lie in a conical surface plane having an included cone angle (θ) in the range of from 20° to 160°.

17. A device according to claim 4 wherein the nozzle orifices widen towards their outlet ends.

18. A device according to claim 4 wherein are provided from 10 to 25 blade portions.

19. A device according to claim 18 wherein are provided from 12 to 18 blade portions.

20. A device according to claim 4 wherein is provided a water resistant bearing between said rotor and said stator.
